(19) United States
(12) Patent Application Publication
(10) Pub. No.: US 2025/0370108 A1
(43) Pub. Date: Dec. 4, 2025

(54) TECHNIQUES FOR MIRROR DOPPLER SPREAD COMPENSATION

(71) Applicant: AEVA, INC., Mountain View, CA (US)

(72) Inventors: Md Rafiul Amin, Fremont, CA (US); Jose Krause Perin, Mountain View, CA (US); Kumar Bhargav Viswanatha, Santa Clara, CA (US)

(21) Appl. No.: 18/731,728

(22) Filed: Jun. 3, 2024

(51) Int. Cl. G01S 7/497; G01S 7/481

(52) U.S. Cl. CPC G01S 7/497; G01S 7/4817

(57) ABSTRACT

A method of a LIDAR system to compensate for mirror Doppler spread includes transmitting an optical beam towards a target, receiving a return signal from the target, and generating an electrical signal comprising a set of frequencies in a first frequency spectrum. The method further includes determining a value for each of a set of scanning parameters associated with the target, determining a spread function for the frequency spectrum based on the values for each of the scanning parameters, and performing a correction of the frequency spectrum based on the spread function.

### TECHNICAL FIELD

The present disclosure relates generally to light detection and ranging (LIDAR) systems, for example, techniques to compensate for mirror Doppler spreading in coherent LIDAR systems.

### BACKGROUND

Frequency-Modulated Continuous-Wave (FMCW) LIDAR systems include several possible phase impairments such as laser phase noise, circuitry phase noise, flicker noise that the driving electronics inject on a laser, drift over temperature/weather, and chirp rate offsets. A scanning FMCW LIDAR system may use a moving scanning mirror to steer light beams and scan a target or a target environment. To achieve a wide field of view and high frame rates, the scanning mirror may have a high angular speed. The high mirror angular speed may cause several impairments. For example, the mirror-induced Doppler shift at different parts of the laser beam on the mirror may broaden the received signal bandwidth. The received signal intensity may be lowered, and consequently the detection probability may be reduced. Moreover, the error in range, velocity, and reflectivity measurements may be increased.

### SUMMARY

The present disclosure describes various examples, without limitation, systems and techniques of processing received signal to compensate for mirror Doppler spread effects in LIDAR systems. In some examples, a LIDAR system is disclosed herein. The LIDAR system includes an optical scanner to transmit an optical beam towards, and receive a return signal from, a target, an optical processing system coupled to the optical scanner to generate an electrical signal comprising a plurality of frequencies in a first frequency spectrum, and a signal processing system coupled to the optical processing system. The signal processing system includes a processing device and a memory operatively coupled to the processing device, the memory to store instructions that, when executed by the processing device, cause the LIDAR system to determine a value for each of a set of scanning parameters associated with the optical scanner, determine a spread function for the frequency spectrum based on the values for each of the scanning parameters, and perform a correction of the frequency spectrum based on the spread function.

In some embodiments, to determine the spread function for the frequency spectrum, the processing device selects the spread function from a set of spread functions based on the value for each of the scanning parameters. In some embodiments, the processing device calibrates each of the plurality of spread functions using selected values for the scanning parameters and an expected frequency spectrum. In some embodiments, the scanning parameters include a range of a target, an azimuth of the target, an elevation of the target, an angular velocity of the scanning mirror, and a chirp rate of an optical source of the LIDAR system.

In some embodiments, to calibrate each of the plurality of spread functions, the processing device samples a first signal at a mirror speed of zero using the selected values for the plurality of scanning parameters to determine the expected frequency spectrum, samples a second signal at a non-zero scanning mirror speed using the selected values for the plurality of scanning parameters to determine a doppler spread frequency spectrum, and calculates the spread function associated with the selected values for the plurality of scanning parameters based on the expected frequency waveform and the doppler shifted frequency spectrum. In some embodiments, to perform the correction of the first frequency spectrum based on the spread function, the processing device determines a matched filter associated with the spread function and applies the matched filter to the first frequency waveform to obtain a compensated frequency spectrum. In some embodiments, to perform the correction of the first frequency spectrum based on the spread function, the processing device performs a deconvolution of the first frequency spectrum using the spread function to obtain a compensated frequency spectrum.

In some examples, a method of a LIDAR system to compensate for mirror Doppler spread includes transmitting an optical beam towards a target, receiving a return signal from the target, and generating an electrical signal comprising a set of frequencies in a first frequency spectrum. The method further includes determining a value for each of a set of scanning parameters associated with the target, determining a spread function for the frequency spectrum based on the values for each of the scanning parameters, and performing a correction of the frequency spectrum based on the spread function.

In some examples, a LIDAR apparatus is disclosed herein. The LIDAR apparatus includes an optical scanner to transmit an optical beam and receive a set of return signals from reflections of the optical beam, an optical processing system coupled to the optical scanner, the optical processing system to generate an electrical signal from the set of return signals, the electrical signal including a set of frequencies in a first frequency spectrum, a signal processing system coupled to the optical processing system. The signal processing system includes a memory and circuitry coupled to the memory, the circuitry to determine a value for each of a set of scanning parameters associated with the optical scanner, determine a spread function for the frequency spectrum based on the values for each of the scanning parameters, and perform a correction of the frequency spectrum based on the spread function.

These and other aspects of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and examples, should be viewed as combinable unless the context of the disclosure clearly dictates otherwise.

It will therefore be appreciated that this Summary is provided merely for purposes of summarizing some examples so as to provide a basic understanding of some aspects of the disclosure without limiting or narrowing the scope or spirit of the disclosure in any way. Other examples, aspects, and advantages will become apparent from the following detailed description taken in conjunction with the accompanying figures which illustrate the principles of the described examples.

### BRIEF DESCRIPTION OF THE DRAWINGS

For a more complete understanding of various examples, reference is now made to the following detailed description taken in connection with the accompanying drawings in which like identifiers correspond to like elements:

FIG. 1A is a block diagram illustrating an example LIDAR system according to embodiments of the present disclosure.

FIG. 2 is a time-frequency diagram illustrating an example of FMCW LIDAR waveforms according to embodiments of the present disclosure.

FIG. 3A is a diagram illustrating an example of a received signal power spectrum density (PSD) in a LIDAR system, when the scanning mirror has a low speed, according to embodiments of the present disclosure.

FIG. 3B is a diagram illustrating an example of received signal power spectrum density (PSD) in a LIDAR system, when the scanning mirror has a high speed, according to embodiments of the present disclosure.

FIG. 4A is a diagram illustrating an example calibration of a spread function according to embodiments of the present disclosure.

FIG. 4B is a block diagram illustrating training of a machine learning model to infer a compensated signal frequency spectrum using sampled signal spectrums or waveforms and scanning parameters as training data, according to embodiments of the present disclosure.

FIG. 5 is a diagram illustrating Doppler spread compensation in a LIDAR system 500 via deconvolution of the received signal with a spread function, according to some embodiments.

FIG. 6 illustrates Doppler spread compensation in a LIDAR system via application of a spread function to the received signal as a matched filter, according to some embodiments.

FIG. 7 illustrates Doppler spread compensation in a LIDAR system via a machine learning model trained as a spread function, according to some embodiments.

FIG. 8 is a flow diagram illustrating an example of a process of processing a received signal in a LIDAR system according to embodiments of the present disclosure.

FIG. 9 is a flow diagram illustrating an example of a process of processing a received signal in a LIDAR system according to embodiments of the present disclosure.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

The described LIDAR systems herein may be implemented in any sensing market, such as, but not limited to, transportation, manufacturing, metrology, medical, virtual reality, augmented reality, and security systems. According to some embodiments, the described LIDAR system may be implemented as part of a front-end of frequency modulated continuous-wave (FMCW) device that assists with spatial awareness for automated driver assist systems, or self-driving vehicles.

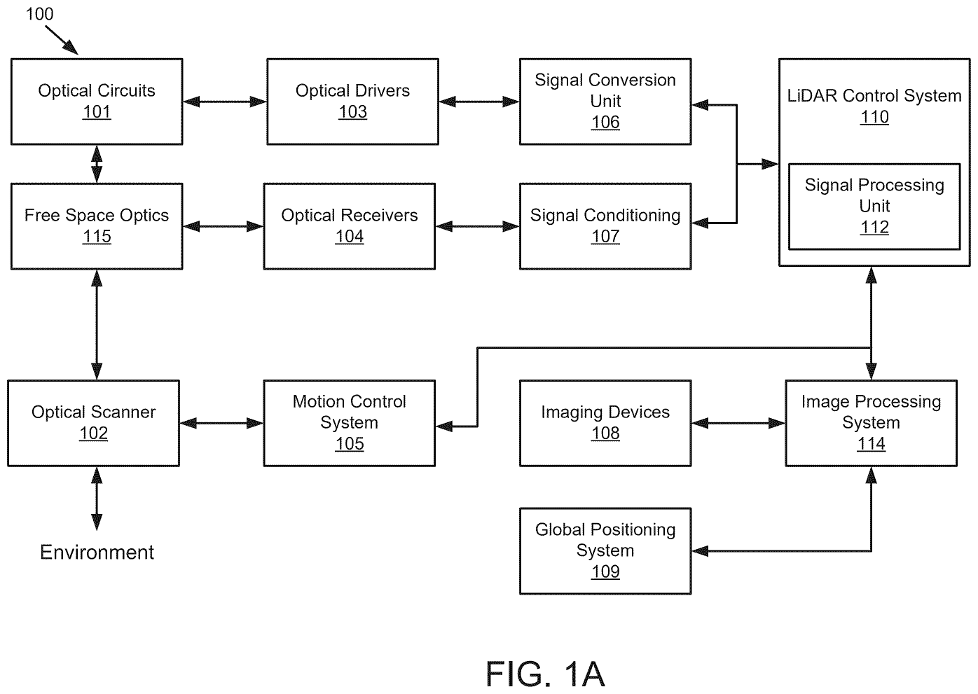

FIG. 1A illustrates a LIDAR system 100 according to example implementations of the present disclosure. The LIDAR system 100 includes one or more of each of a number of components, but may include fewer or additional components than shown in FIG. 1. According to some embodiments, one or more of the components described herein with respect to LIDAR system 100 can be implemented on a photonics chip. The optical circuits 101 may include a combination of active optical components and passive optical components. Active optical components may generate, amplify, and/or detect optical signals and the like. In some examples, the active optical component includes optical beams at different wavelengths, and includes one or more optical amplifiers, one or more optical detectors, or the like.

Free space optics 115 may include one or more optical waveguides to carry optical signals, and route and manipulate optical signals to appropriate input/output ports of the active optical circuit. The free space optics 115 may also include one or more optical components such as taps, wavelength division multiplexers (WDM), splitters/combiners, polarization beam splitters (PBS), collimators, couplers or the like. In some examples, the free space optics 115 may include components to transform the polarization state and direct received polarized light to optical detectors using a PBS, for example. The free space optics 115 may further include a diffractive element to deflect optical beams having different frequencies at different angles.

In some examples, the LIDAR system 100 includes an optical scanner 102 that includes one or more scanning mirrors that are rotatable along an axis (e.g., a slow-moving-axis) that is orthogonal or substantially orthogonal to the fast-moving-axis of the diffractive element to steer optical signals to scan a target environment according to a scanning pattern. For instance, the scanning mirrors may be rotatable by one or more galvanometers. Objects in the target environment may scatter an incident light into a return optical beam or a target return signal. The optical scanner 102 also collects the return optical beam or the target return signal, which may be returned to the passive optical circuit component of the optical circuits 101. For example, the return optical beam may be directed to an optical detector by a polarization beam splitter. In addition to the mirrors and galvanometers, the optical scanner 102 may include components such as a quarter-wave plate, lens, anti-reflective coating window or the like.

To control and support the optical circuits 101 and optical scanner 102, the LIDAR system 100 includes LIDAR control systems 110. The LIDAR control systems 110 may include a processing device for the LIDAR system 100. In some examples, the processing device may be one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. The processing device may also be one or more special-purpose processing devices such as an application specific integrated circuit (ASIC), a field programmable gate array (FPGA), a digital signal processor (DSP), network processor, or the like.

In some examples, the LIDAR control systems 110 may include a signal processing unit 112 such as a digital signal processor (DSP). The LIDAR control systems 110 are configured to output digital control signals to control optical drivers 103. In some examples, the digital control signals may be converted to analog signals through signal conversion unit 106. For example, the signal conversion unit 106 may include a digital-to-analog converter. The optical drivers 103 may then provide drive signals to active optical components of optical circuits 101 to drive optical sources such as lasers and amplifiers. In some examples, several optical drivers 103 and signal conversion units 106 may be provided to drive multiple optical sources.

The LIDAR control systems 110 are also configured to output digital control signals for the optical scanner 102. A motion control system 105 may control the galvanometers of the optical scanner 102 based on control signals received from the LIDAR control systems 110. For example, a digital-to-analog converter may convert coordinate routing information from the LIDAR control systems 110 to signals interpretable by the galvanometers in the optical scanner 102. In some examples, a motion control system 105 may also return information to the LIDAR control systems 110 about the position or operation of components of the optical scanner 102. For example, an analog-to-digital converter may in turn convert information about the galvanometers' position to a signal interpretable by the LIDAR control systems 110.

The LIDAR control systems 110 are further configured to analyze incoming digital signals. In this regard, the LIDAR system 100 includes optical receivers 104 to measure one or more beams received by optical circuits 101. For example, a reference beam receiver may measure the amplitude of a reference beam from the active optical component, and an analog-to-digital converter converts signals from the reference receiver to signals interpretable by the LIDAR control systems 110. Target receivers measure the optical signal that carries information about the range and velocity of a target in the form of a beat frequency, modulated optical signal. The reflected beam may be mixed with a second signal from a local oscillator. The optical receivers 104 may include a high-speed analog-to-digital converter to convert signals from the target receiver to signals interpretable by the LIDAR control systems 110. In some examples, the signals from the optical receivers 104 may be subject to signal conditioning by signal conditioning unit 107 prior to receipt by the LIDAR control systems 110. For example, the signals from the optical receivers 104 may be provided to an operational amplifier for amplification of the received signals and the amplified signals may be provided to the LIDAR control systems 110.

In some applications, the LIDAR system 100 may additionally include one or more imaging devices 108 configured to capture images of the environment, a global positioning system 109 configured to provide a geographic location of the system, or other sensor inputs. The LIDAR system 100 may also include an image processing system 114. The image processing system 114 can be configured to receive the images and geographic location, and send the images and location or information related thereto to the LIDAR control systems 110 or other systems connected to the LIDAR system 100.

In operation according to some examples, the LIDAR system 100 is configured to use nondegenerate optical sources to simultaneously measure range and velocity across two dimensions. This capability allows for real-time, long range measurements of range, velocity, azimuth, and elevation of the surrounding environment.

In some examples, the scanning process begins with the optical drivers 103 and LIDAR control systems 110. The LIDAR control systems 110 instruct the optical drivers 103 to independently modulate one or more optical beams, and these modulated signals propagate through the passive optical circuit to the collimator. The collimator directs the light at the optical scanning system that scans the environment over a preprogrammed pattern defined by the motion control system 105. The optical circuits 101 may also include a polarization wave plate (PWP) to transform the polarization of the light as it leaves the optical circuits 101. In some examples, the polarization wave plate may be a quarter-wave plate or a half-wave plate. A portion of the polarized light may also be reflected back to the optical circuits 101. For example, lensing or collimating systems used in LIDAR system 100 may have natural reflective properties or a reflective coating to reflect a portion of the light back to the optical circuits 101.

Optical signals reflected back from the environment pass through the optical circuits 101 to the receivers. Because the polarization of the light has been transformed, it may be reflected by a polarization beam splitter along with the portion of polarized light that was reflected back to the optical circuits 101. Accordingly, rather than returning to the same fiber or waveguide as an optical source, the reflected light is reflected to separate optical receivers. These signals interfere with one another and generate a combined signal. Each beam signal that returns from the target produces a time-shifted waveform. The temporal phase difference between the two waveforms generates a beat frequency measured on the optical receivers (photodetectors). The combined signal can then be reflected to the optical receivers 104.

The analog signals from the optical receivers 104 are converted to digital signals using analog to digital converters (ADCs). The digital signals are then sent to the LIDAR control systems 110. A signal processing unit 112 may then receive the digital signals and interpret them. In some embodiments, the signal processing unit 112 also receives position data from the motion control system 105 and galvanometers (not shown) as well as image data from the image processing system 114. The signal processing unit 112 can then generate a 3D point cloud with information about range and velocity of points in the environment as the optical scanner 102 scans additional points. The signal processing unit 112 can also overlay a 3D point cloud data with the image data to determine velocity and distance of objects in the surrounding area. The system also processes the satellite-based navigation location data to provide a precise global location.

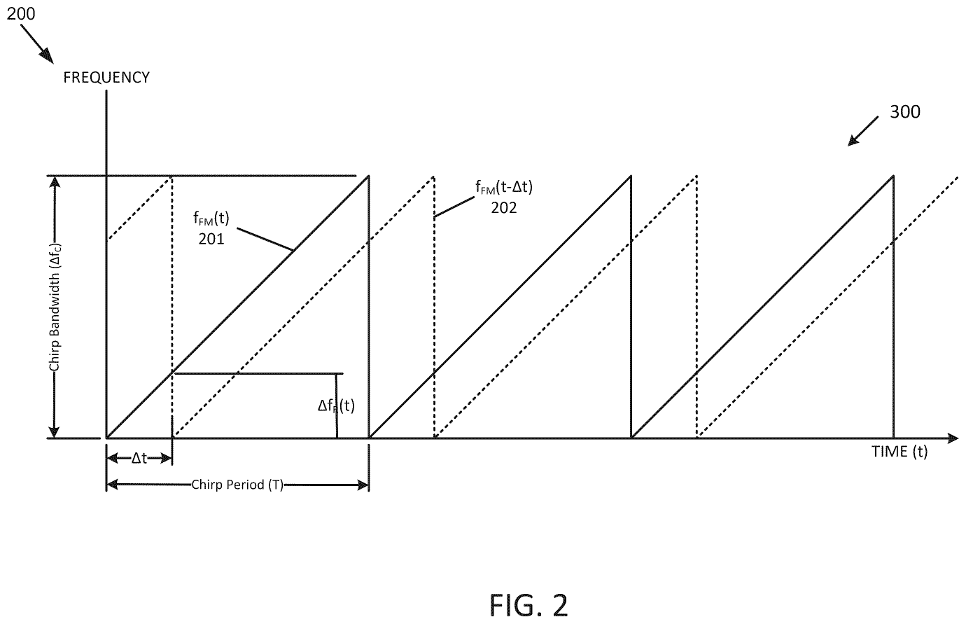

FIG. 2 is a time-frequency diagram 200 of an FMCW scanning signal 101b that can be used by a LIDAR system, such as system 100, to scan a target environment according to some embodiments. In one example, the scanning waveform 201, labeled as f_{FM}(t), is a sawtooth waveform (sawtooth “chirp”) with a chirp bandwidth Δf_{C} and a chirp period T_{C}. The slope of the sawtooth is given as k=(Δf_{C}/T_{C}). FIG. 2 also depicts target return signal 202 according to some embodiments. Target return signal 202, labeled as f_{FM}(t−Δt), is a time-delayed version of the scanning signal 201, where Δt is the round trip time to and from a target illuminated by scanning signal 201. The round trip time is given as Δt=2R/v, where R is the target range and v is the velocity of the optical beam, which is the speed of light c. The target range, R, can therefore be calculated as R=c(Δt/2). When the return signal 202 is optically mixed with the scanning signal, a range-dependent difference frequency (“beat frequency”) Δf_{R}(t) is generated. The beat frequency Δf_{R}(t) is linearly related to the time delay Δt by the slope of the sawtooth k. That is, Δf_{R}(t)=kΔt. Since the target range R is proportional to Δt, the target range R can be calculated as R=(c/2)(Δf_{R}(t)/k). That is, the range R is linearly related to the beat frequency Δf_{R}(t). The beat frequency Δf_{R}(t) can be generated, for example, as an analog signal in optical receivers 104 of system 100. The beat frequency can then be digitized by an analog-to-digital converter (ADC), for example, in a signal conditioning unit such as signal conditioning unit 107 in LIDAR system 100. The digitized beat frequency signal can then be digitally processed, for example, in a signal processing unit, such as signal processing unit 112 in system 100. It should be noted that the target return signal 202 will, in general, also includes a frequency offset (Doppler shift) if the target has a velocity relative to the LIDAR system 100. The Doppler shift can be determined separately, and used to correct the frequency of the return signal, so the Doppler shift is not shown in FIG. 2 for simplicity and ease of explanation. It should also be noted that the sampling frequency of the ADC will determine the highest beat frequency that can be processed by the system without aliasing. In general, the highest frequency that can be processed is one-half of the sampling frequency (i.e., the “Nyquist limit”). In one example, and without limitation, if the sampling frequency of the ADC is 1 gigahertz, then the highest beat frequency that can be processed without aliasing (Δf_{Rmax}) is 500 megahertz. This limit in turn determines the maximum range of the system as Rₘₐₓ=(c/2)(Δf_{Rmax}/k) which can be adjusted by changing the chirp slope k. In one example, while the data samples from the ADC may be continuous, the subsequent digital processing described below may be partitioned into “time segments” that can be associated with some periodicity in the LIDAR system 100. In one example, and without limitation, a time segment might correspond to a predetermined number of chirp periods T, or a number of full rotations in azimuth by the optical scanner.

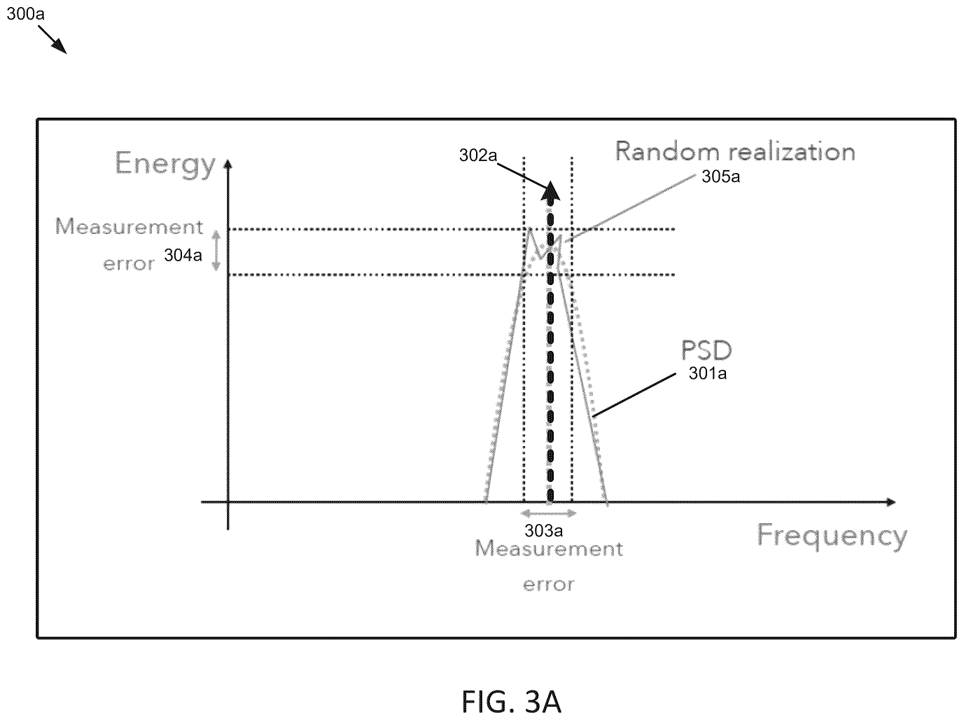

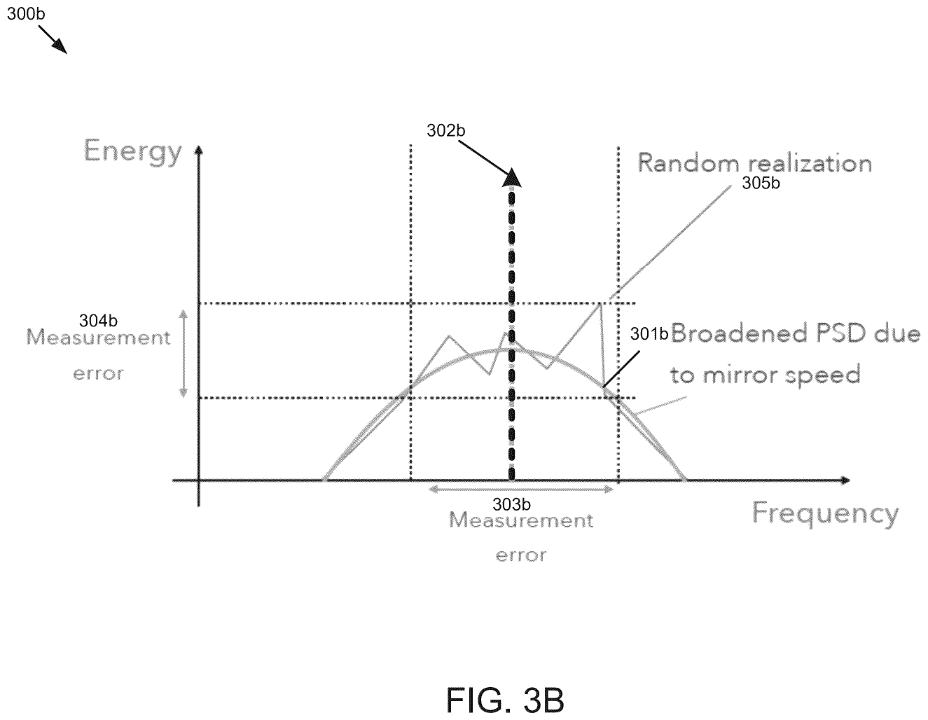

FIG. 3A is a diagram 300a illustrating an example of received signal power spectrum density (PSD) 301a in a LIDAR system, when the scanning mirror is stationary (e.g., zero speed) or has a relatively low speed. FIG. 3B is a diagram illustrating an example of received signal power spectrum density (PSD) in a LIDAR system, when the scanning mirror has a high speed. A scanning LIDAR system (e.g., FMCW LIDAR) may use a moving scanning mirror to steer light beams and scan a target or a target environment. To achieve a wide field of view and high frame rates, the scanning mirror may have a high angular speed. In some scenarios, the high mirror angular speed may cause several impairments. For example, a mirror-induced Doppler shift caused by the angular velocity of the scanning mirror may broaden the received signal bandwidth (e.g., by shifting a portion of the output beam up in frequency and a portion of the output beam down in frequency). Also, the return beam experiences similar spectrum broadening upon return when it reflects from the scanning mirror before being detected at the receiver optical detector. As such, in these scenarios, the received signal intensity may be lowered due to larger energy or power distribution of the frequencies of the return signal, and consequently the detection probability may be reduced and cause an increase in errors related to range, velocity, and reflectivity measurements.

Referring to FIG. 3A and FIG. 3B, the moving scanning mirror (e.g., scanning mirror included as part of system 100 in FIG. 1) may induce Doppler Shift on the outgoing light beam and the incoming light beam, which may be the target return signal. As depicted in FIG. 3A, when the scanning mirror is moving at a low mirror speed (e.g., <5 kdeg/s), the mirror-induced Doppler has little impact on the signal quality. The peak value 302a may be detected in the PSD 301a of the received signal. The received signal may have random realization 305a, which may be minor. The received signal may have a reasonable range of frequency measurement error 303a and a reasonable range of power measurement error 304a.

As depicted in FIG. 3B, when the scanning mirror is moving at a high mirror speed (>5 kdeg/s), there may be a significant broadening of the signal power spectrum density (PSD) 301b. As a result, the measured signal energy may be lower on average. Thus, the probability of detection may be consequently reduced. The measurement error on frequency 303b and/or the measurement error on energy 304 b may be higher due to the randomness (e.g., random realization 305b) of the signal.

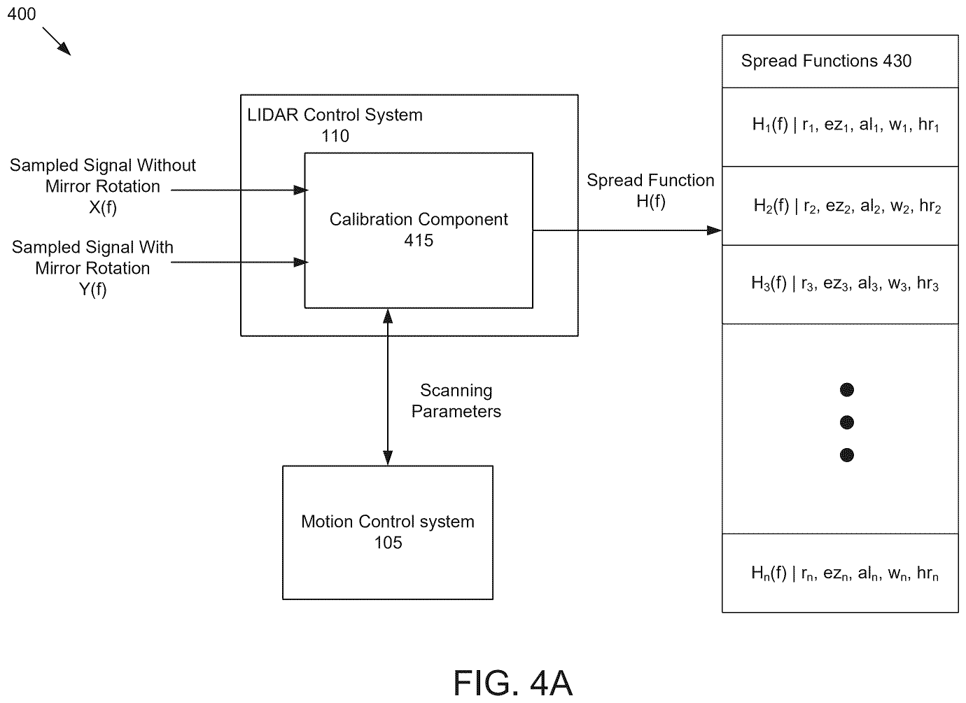

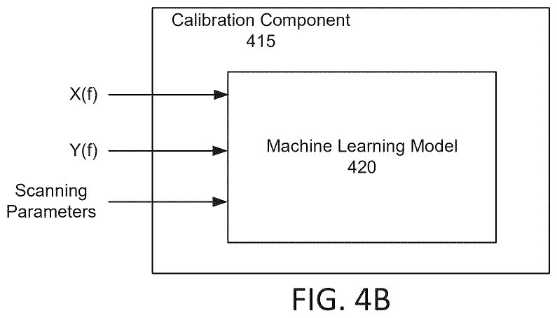

FIG. 4A is a diagram 400 illustrating an example calibration of a spread function according to embodiments of the present disclosure. In some embodiments, the LIDAR control system 110 may include a calibration component 415 for determining and calibrating a spread function. In some embodiments the calibration component 415 may receive one or more sampled signals (e.g., a frequency spectrum or waveform) that were generated without rotation of a scanning mirror such that there is no mirror Doppler effect expected. Additionally, the calibration component may receive a sampled signal with a selected scanning mirror rotation speed for generation of a spread function corresponding to the selected speed. In some embodiments, the calibration component 415 may further receive or determine scanning parameters from the motion control system 105 or the LIDAR control system 110. For example, the scanning parameters may include a known range of a target, an azimuth and elevation of the target (e.g., with respect to the LIDAR system), a chirp rate of an optical source, or any combination thereof. Additionally, any other parameters or variables that may affect a mirror Doppler spread of an optical beam may be used. The calibration component 415 may then determine a spread function (e.g., H(f)) based on the signals sampled without mirror rotation and the signals with mirror rotation. In particular, the calibration component 415 may determine a spread function that, when applied as a convolution to the signals sampled without mirror rotation, produces the signals sampled with the mirror rotation.

As provided in FIG. 4A, the signal sampled without mirror rotation may be represented as X(f) and the signal sampled with a non-zero scanning mirror rotation may be represented as Y(f). If the spread function is defined as H(f) then the relation between X(f) and Y(f) may be represented as:

$$Y ( f ) = H ( f ) * X ( f )$$

Here, “*” represents the convolution or element-wise multiplication between H(f) and X(f). Accordingly, if solved for H(f) then the spread function can be determined from the known spectrums of the sampled signals X(f) and Y(f). However, in order to also account for noise in the LIDAR system, the equation may be written as follows:

$${Y}_{i} ( f ) = H ( f ) * {X}_{i} ( f ) + {N}_{i} ( f )$$

Here, N(f) represents a noise function which indicates an expected noise in the signal spectrum of X(f) and Y(f). In some embodiments, N(f) may be a gaussian noise distribution, however any noise function or distribution may be used. In order to numerically solve for H(f), an optimization problem may be formulated based on the above equation. For example, the calibration component 415 of FIG. 4A may use a least square optimization problem to solve for H(f), as follows:

$${min}_{H ( f )} \sum ( \frac{1}{2} {‖ {Y}_{i} ( f ) - H ( f ) * {X}_{i} ⋆ ( f ) ‖}_{2}^{2} + λ G ( H ( f ) ) )$$

Here, G represents a penalization on parameters in H(f) to avoid overfitting or convergence to unstable solutions. Additionally, X(f), H(f), and Y(f) are vectors representing several signal spectrums sampled within a particular range of the scanning parameters.

After generation of the spread function H(f), the LIDAR control system 110 may store the spread function in memory with several spread functions 430 determined for various combinations of the scanning parameters. As described in more detail below, when performing a target detection, a spread function of the spread functions 430 may be selected based on measured values for the scanning parameters. The selected spread function may then be used for mirror Doppler spread compensation.

FIG. 4B illustrates training of a machine learning model to infer a compensated signal frequency spectrum using sampled signal spectrums or waveforms and scanning parameters as training data. For example, calibration component 415 may additionally, or alternatively, train machine learning model 420 to estimate a signal frequency waveform based on an input frequency waveform collected for a target and the scanning parameters associated with the output beam from which a return signal from the target is received. In some embodiments, training data may be generated by selecting a set of scanning parameter values and generating a signal for those selected set of scanning parameters while scanning mirror speed is zero (X(f)) as well as at one or more non-zero scanning mirror speeds (Y(f)). Accordingly, the machine learning model 420 may operate as a spread function, or inverse spread function, to infer what the signal should look like without mirror Doppler spread based on what the scanning parameter values are that were used to produce a generated signal.

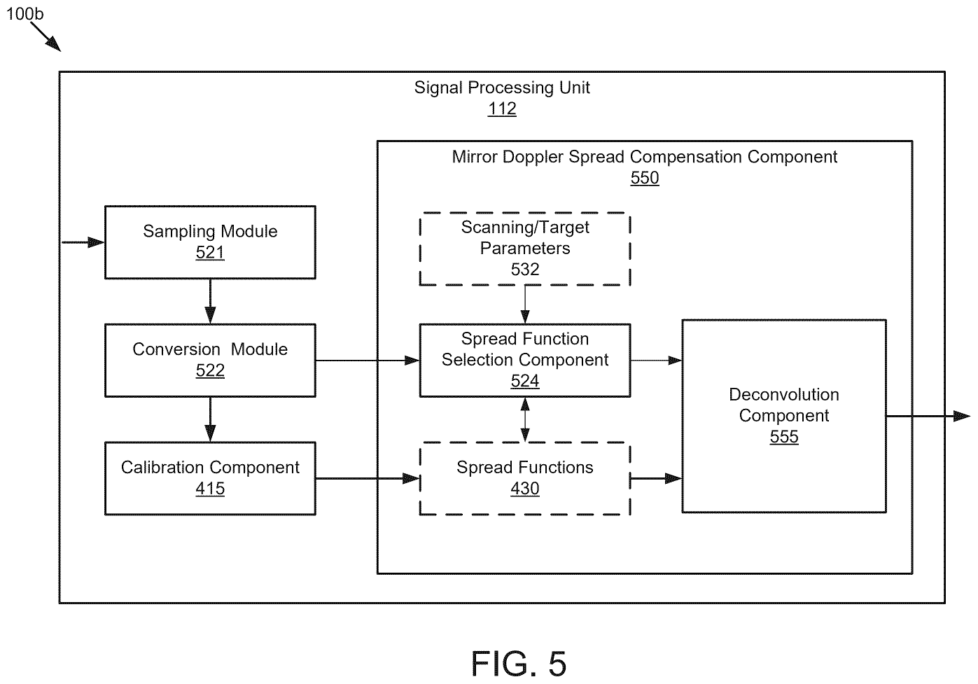

FIG. 5 illustrates Doppler spread compensation in a LIDAR system 500 via deconvolution of the received signal with a spread function, according to some embodiments. The LIDAR system 500 includes signal processing unit 112 which may include components for generating a signal magnitude-frequency spectrum from an electrical signal representing a beat signal produced by an optical received of the LIDAR system. For example, as depicted in FIG. 5, the signal processing unit may include a sampling module 521 for sampling the electrical signal from the optical detector. The sampled signals may include a magnitude and an associated frequency. The conversion module 522 may convert the sampled signals into a magnitude-frequency spectrum in which peaks represent a target detection. For example, the conversion module 522 may generate the magnitude-frequency spectrum by binning each of the sampled signal magnitudes into a frequency range. As discussed above, during calibration for mirror Doppler spread compensation, the calibration component 415 may generate several spread functions 430 for various values of several scanning parameters. Accordingly, each spread function of the spread functions 430 (e.g., stored in memory of the LIDAR system) may be optimally applied to a certain range of values of the scanning parameters.

In some embodiments, during operation of the LIDAR system 500 (e.g., once calibration is completed by the calibration component 415) the mirror Doppler spread compensation component 550 may receive a magnitude-frequency waveform of a detected signal from the conversion module 522. The mirror Doppler spread compensation component 550 may include spread function selection component 524 which selects which spread function to apply to the received magnitude-frequency spectrum based on the scanning and target parameters 532 associated with the received signal. For example, the scanning/target parameters at the time of transmitting an optical beam may be collected and used to select the spread function to be applied to the magnitude-frequency spectrum generated by the reflected return signal from the optical beam. In some embodiments, the spread function selection component 524 may apply a set of heuristics to the scanning/target parameters 532 to determine the optical spread function to be applied to the received signal. In some embodiments, the spread function selection component 524 may apply a weighted selection scheme based on a determined correlation between certain parameters 532 and the mirror doppler spread such that the more highly weighted parameters will be emphasized over less heavily weighted parameters during spread function selection.

In some embodiments, after selection of the spread function from the possible spread functions 430, a deconvolution component 555 may apply the selected spread function to the received signal magnitude-frequency waveform to compensate for mirror Doppler spread. In some embodiments, the deconvolution component 555 may perform a deconvolution of the magnitude-frequency waveform using the spread function. For example, the general deconvolution framework may include solving of an optimization problem, such as the following:

$${min}_{X ( f )} {‖ Y ( f ) - H ( f ) * X ( f ) ‖}_{2}^{2} + γ F ( X ( f ) )$$

Here, F(X(y)) regularizes the constraints on X(f) based on a-priori knowledge and information. Additionally, γ is a regularizing scaling factor. Where the scaling factor is zero, the solution for the deconvolution is as follows:

$$X ( f ) = Y ( f ) ∅ H ( f )$$

In the above example, the solution reduces to the deconvolution or element-wise division, where Ø is the element-wise division operator. As another example, if F(x) is the L1 norm of x, which encourages sparsity of X(f) to provide a sharper peak, then the deconvolution becomes the following:

$${{min}_{X ( f )} {‖ Y ( f ) - H ( f ) * X ( f ) ‖}_{2}^{2} + γ X ( f ) ‖}_{1}$$

To solve the above deconvolution, embodiments may use an iterative reweighted least squared (IRLS) approach, or any other sparse recovery approach. Assuming that at the kth iteration a solution X(k) exists, the optimization problem may be written as follows:

$${min}_{X ( f )} {‖ Y ( f ) - H ( f ) * X ( f ) ‖}_{2}^{2} + γ {W}^{( k )} F {‖ X ( f ) ‖}_{2}^{2}$$

Here, W^{(k)} is a diagonal matrix and

$${W}_{m , m} = \frac{1}{\vert {x}_{m} \vert}$$

and the solution for the k+1 iteration is:

$${X}^{( k + 1 )} = {( {\tilde{H}}^{T} \tilde{H} + γ {W}^{( k )} )}^{- 1} \tilde{H} Y ( f )$$

Here, \tilde{H} is a diagonal of H(f). Embodiments may begin the iteration with X(0)=Y(f). Accordingly, the solution to the optimization problem may be a compensated signal spectrum for a target detection. The compensated signal spectrum may then be input into the peak selection process to extract the range and velocity information. A peak value search may be performed to detect a peak value from the received signal. Then, range and velocity information of the target may be extracted based on the peak value in the received signal.

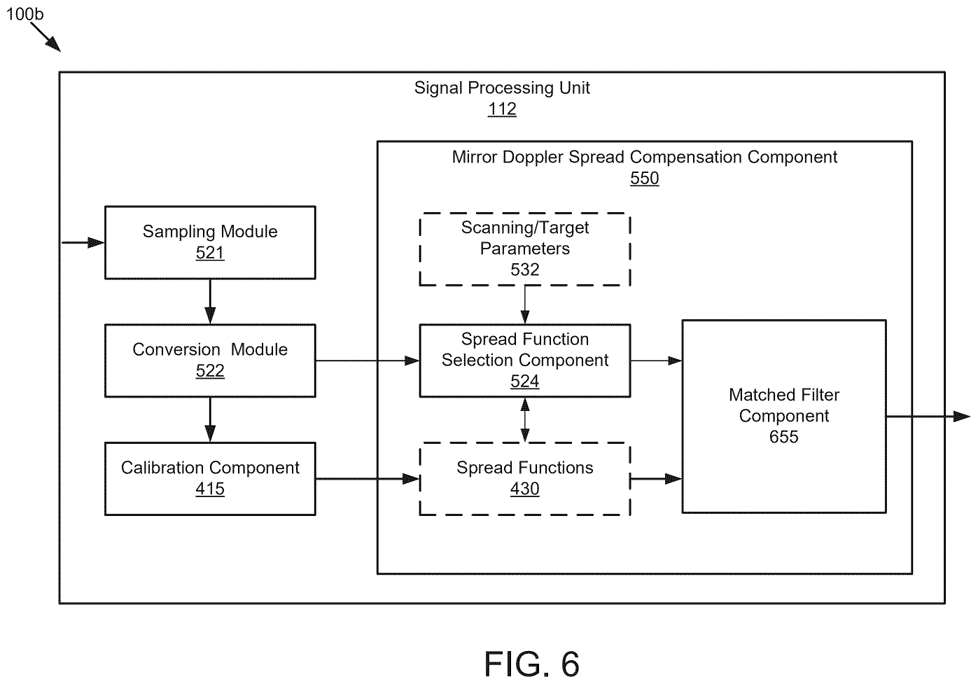

FIG. 6 illustrates Doppler spread compensation in a LIDAR system via application of a spread function to the received signal as a matched filter, according to some embodiments. The components of FIG. 6 may be substantially the same as those of FIG. 5, except for the matched filter component 655 of the mirror Doppler spread compensation component 550. Accordingly, in the depicted embodiment the mirror Doppler spread compensation component 550 may use the matched filter component 655 to apply the selected spread function as a matched filter for compensating the received signal spectrum for mirror Doppler spread.

Under the matched filtering approach, the received signal is filtered by a matched filter in the frequency domain, where the matched filter includes an expected received signal shape or waveform in the frequency domain. The expected received signal frequency waveform of a magnitude-frequency spectrum may be determined using the selected spread function as applied to a signal peak (e.g., a peak without mirror Doppler spread).

Referring to FIG. 6, a received signal in the frequency domain, for example, an input spectrum, may be input into the matched filter component 655. The received signal 655 may include a first frequency waveform, which may be an unknown waveform, e.g., at a starting point of a matched filtering process. The matched filter component 655 may generate a second frequency waveform based on the spread function. The second frequency waveform may be the expected received signal frequency waveform. In some embodiments, the second frequency waveform may be an expectation or an estimation or an approximation of the first frequency waveform, determined based on the selected spread function as applied to an ideal peak without mirror Doppler spread.

In one embodiment, the second frequency waveform may be based on an estimation of a power spectrum density (PSD) function of the received signal. For example, the matched filter component 655 may include an expected received signal PSD. The matched filter component 655 may be configured to compare the expected received signal PSD to the first frequency waveform and determine if there is a match.

In one embodiment, a set of filter coefficients may be determined and updated according to a set of metrics of the LIDAR system 600. In some embodiments, the filter coefficients are static, while in other embodiments, they are dynamically updated. In one embodiment, the filter coefficients may be updated continuously, e.g., updated per 1 millisecond, 1 second, 15 seconds, 30 seconds, or any values therebetween. For another example, the filter coefficients may be updated when detecting there is a change in the angular speed of the scanning mirror, the position of the scanning mirror, the optical scanner geometry, or the target, etc.

According to some embodiments, the matched filter component 655 may determine a compensated peak based on convolving waveforms. For example, in one scenario, the matched filter component 655 may compare the received signal (e.g., the first frequency waveform) with the expected received signal (e.g., the second frequency waveform) to determine a similarity between them. As an example, the matched filter component 655 may be configured to calculate a cross-correlation of the received signal PSD with the expected received signal PSD. For example, the maximum correlation value may represent the peak value of the received signal.

If the second frequency waveform which is the filtering known waveform is the complex conjugate of the received signal waveform which is the unknown waveform, then the signal-to-noise ratio (SNR) and probability of detection will be maximized by the matched filter component 655. In one embodiment, the filtered received signal is input into a peak selection process to extract the range and velocity information. A peak value search may be performed to detect a peak value from the received signal. Then, range and velocity information of the target may be extracted based on the peak value in the received signal. As the detection occurs at the point where SNR is maximized, the method may result in more accurate frequency and energy measurements, thereby increasing the accuracy in range and velocity measurements of the target.

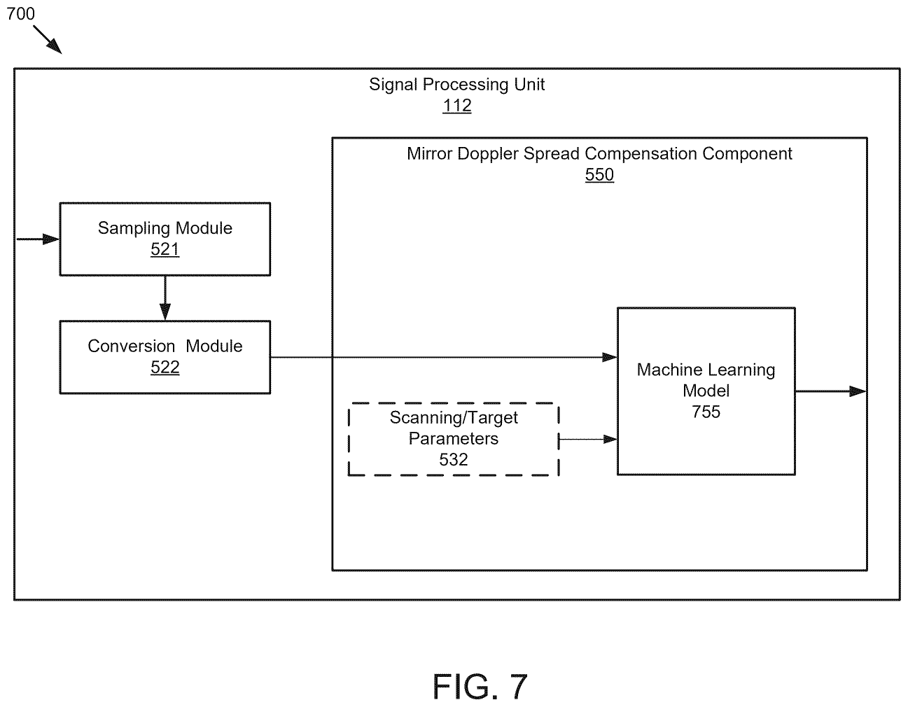

FIG. 7 illustrates Doppler spread compensation in a LIDAR system via a machine learning model trained as an inverse spread function, according to some embodiments. The components of FIG. 7 may be substantially the same as those of FIGS. 5 and 6, except that the mirror Doppler spread compensation component 550 may include a trained machine learning model 755 for compensating a received signal spectrum for mirror Doppler spread. For example, as described above with respect to FIG. 4B, the machine learning model 755 may be trained to emulate the spread function or an inverse of the spread function to infer a compensated frequency spectrum from a received signal frequency spectrum. For example, the machine learning model 755 may apply the following function:

$$X ( f ) = J ( Y ( f ) , r , az , el , ω , fr )$$

Here, the Y(f), r, az, el, ω, and fr are measurements from the LIDAR system 700. In particular, r is the range to the target, az is the azimuth angle to the target, el is the elevation of the target, ω is the angular speed of the scanning mirror, and fr is the chirp rate of the output optical beam. The model may receive these measurements and output a compensated signal spectrum. The compensated signal spectrum may then be input into the peak selection process to extract the range and velocity information. A peak value search may be performed to detect a peak value from the received signal. Then, range and velocity information of the target may be extracted based on the peak value in the received signal.

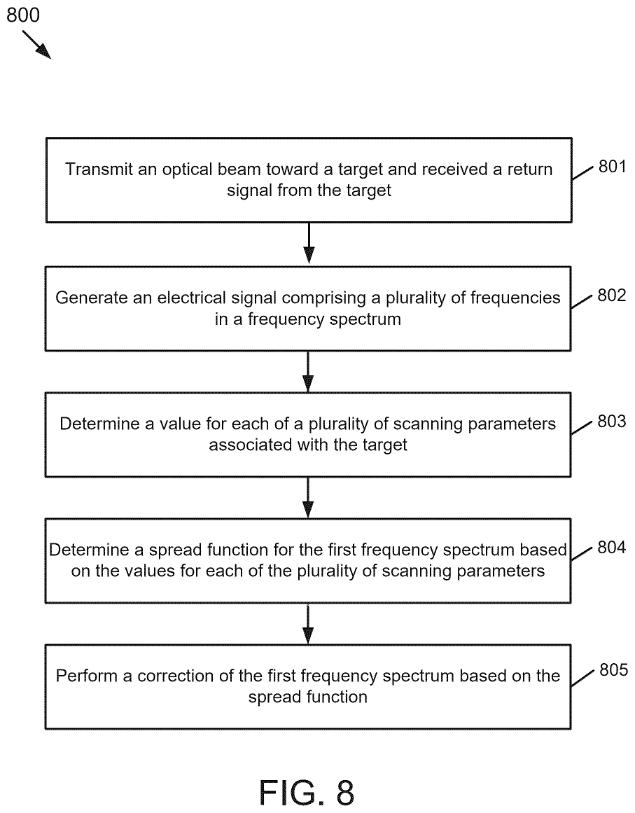

FIG. 8 is a flow diagram illustrating an example of a process 800 of mirror Doppler spread compensation of a received signal in a LIDAR system according to embodiments of the present disclosure. Process 800 may be performed by processing logic which may include software, hardware, or a combination thereof. The software may be stored on a non-transitory machine readable storage medium (e.g., on a memory device). For example, the process 800 may be performed by the mirror Doppler spread compensation component, as illustrated in FIGS. 5-7. By this process, more accurate frequency and energy measurements may be achieved, thereby increasing the accuracy in range and velocity measurements of the target.

At block 801, an optical beam is transmitted toward a target and a return signal is received from the target. At block 802, an electrical signal is generated comprising a plurality of frequencies in a first frequency spectrum.

At block 803, a value is determined for each of a plurality of scanning parameters associated with the target. In some embodiments, the scanning parameters may include a range of a target, an azimuth of the target, an elevation of the target, an angular velocity of the scanning mirror, and a chirp rate of an optical source of the LIDAR system.

At block 804, a spread function is determined for the first frequency spectrum based on the values for each of the plurality of scanning parameters. In some embodiments, several spread functions may be calibrated using selected values for the scanning parameters and an expected frequency spectrum for a return signal. In some embodiments, the expected frequency spectrum may be obtained by performing a detection of a known target at a scanning mirror speed of zero, such that no mirror Doppler effect occurs in the signal. In some embodiments, a second signal is sampled for the known target at a non-zero scanning mirror speed using the selected values for the scanning parameters to determine a doppler shifted frequency spectrum. The spread function, associated with the selected values for the plurality of scanning parameters, is then calculated based on the expected frequency spectrum and the doppler shifted frequency spectrum. In some embodiments, the spread function is selected from the plurality of spread functions based on the values for the scanning parameters determined at block 803.

At block 805, a correction is performed on the first frequency spectrum based on the spread function. select the spread function from a plurality of spread functions based on the value for each of the plurality of scanning parameters. In some embodiments, the correction includes performing a deconvolution of the first frequency spectrum using the spread function to obtain a compensated frequency spectrum. In other embodiments, the correction includes determining a matched filter associated with the spread function and applying the matched filter to the first frequency waveform to obtain a compensated frequency spectrum. In some embodiments, range and velocity information is extracted from the compensated frequency spectrum. In one embodiment, the compensated frequency spectrum is input into a peak selection process to extract the range and velocity information. For example, a peak value of the compensated frequency spectrum is detected to extract range and velocity information of the target.

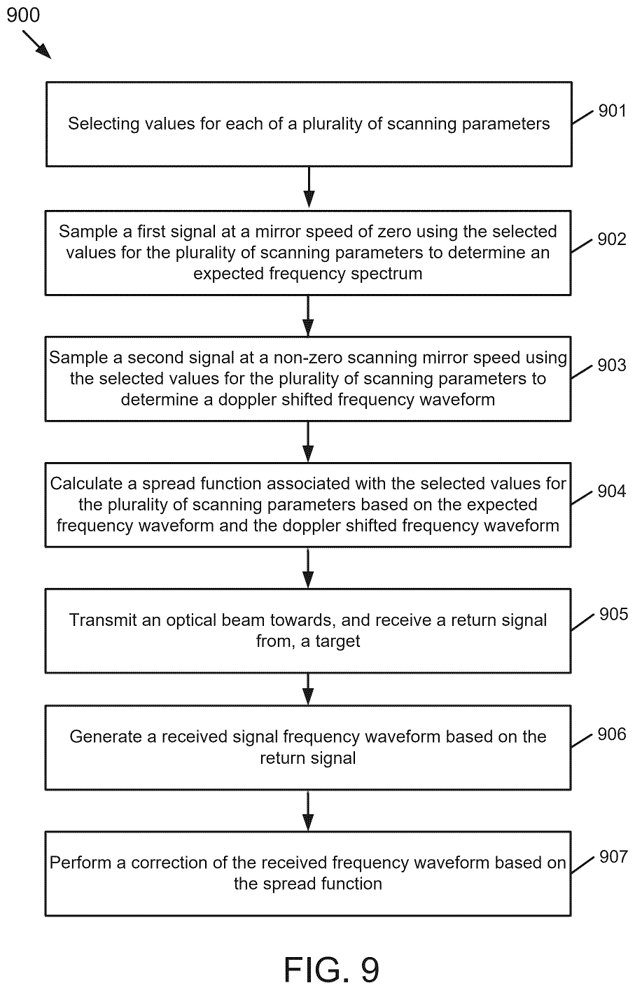

FIG. 9 is a flow diagram illustrating an example of a process 900 of mirror Doppler spread compensation of a received signal in a LIDAR system according to embodiments of the present disclosure. Process 900 may be performed by processing logic which may include software, hardware, or a combination thereof. The software may be stored on a non-transitory machine readable storage medium (e.g., on a memory device). For example, the process 900 may be performed by the mirror Doppler spread compensation component, as illustrated in FIGS. 5-7. By this process, more accurate frequency and energy measurements may be achieved, thereby increasing the accuracy in range and velocity measurements of the target.

At block 901, values are selected for each of a plurality of scanning parameters. At block 902, a first signal is sampled at a scanning mirror speed of zero using the selected values for the plurality of scanning parameters to determine an expected frequency spectrum. At block 903, a second signal is sampled at a non-zero scanning mirror speed using the selected values for the plurality of scanning parameters to determine a mirror Doppler shifted frequency spectrum. At block 904, a spread function is calculated based on the expected frequency spectrum and the mirror Doppler shifted frequency spectrum, wherein the spread function is associated with the selected values for the plurality of scanning parameters.

At block 905, an optical beam is transmitted towards, and a return signal is received from, a target. At block 906, a received signal frequency spectrum is generated based on the return signal. At block 907, a correction is performed on the received frequency spectrum based on the spread function.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Any reference throughout this specification to “one example” or “an example” means that a particular feature, structure, or characteristic described in connection with the examples are included in at least one example. Therefore, the appearances of the phrase “in one example” or “in an example” in various places throughout this specification are not necessarily all referring to the same example.

Although the operations of the methods herein are shown and described in a particular order, the order of the operations of each method may be altered so that certain operations may be performed in an inverse order or so that certain operations may be performed, at least in part, concurrently with other operations. Instructions or sub-operations of distinct operations may be performed in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A light detection and ranging (LIDAR) system, comprising:
an optical scanner to transmit an optical beam towards, and receive a return signal from, a target;
an optical processing system coupled to the optical scanner to generate an electrical signal comprising a plurality of frequencies in a first frequency spectrum; and
a signal processing system coupled to the optical processing system, comprising:
a processing device; and
a memory operatively coupled to the processing device, the memory to store instructions that, when executed by the processing device, cause the LIDAR system to:
determine a value for each of a plurality of scanning parameters associated with the optical scanner;
determine a spread function for the frequency spectrum based on the values for each of the plurality of scanning parameters; and
perform a correction of the frequency spectrum based on the spread function.

2. The LIDAR system of claim 1, wherein to determine the spread function for the frequency spectrum, the processing device is to:
select the spread function from a plurality of spread functions based on the value for each of the plurality of scanning parameters.

3. The LIDAR system of claim 2, wherein the processing device is further to:
calibrate each of the plurality of spread functions using selected values for the plurality of scanning parameters and an expected frequency spectrum.

4. The LIDAR system of claim 3, wherein the plurality of scanning parameters comprises a range of a target, an azimuth of the target, an elevation of the target, an angular velocity of the scanning mirror, and a chirp rate of an optical source of the LIDAR system.

5. The LIDAR system of claim 3, wherein to calibrate each of the plurality of spread functions, the processing device is to:
sample a first signal at a mirror speed of zero using the selected values for the plurality of scanning parameters to determine the expected frequency spectrum;
sample a second signal at a non-zero scanning mirror speed using the selected values for the plurality of scanning parameters to determine a doppler spread frequency spectrum; and
calculate the spread function associated with the selected values for the plurality of scanning parameters based on the expected frequency waveform and the doppler shifted frequency spectrum.

6. The LIDAR system of claim 1, wherein to perform the correction of the first frequency spectrum based on the spread function, the processing device is to:
determine a matched filter associated with the spread function; and
apply the matched filter to the first frequency waveform to obtain a compensated frequency spectrum.

7. The LIDAR system of claim 1, wherein to perform the correction of the first frequency spectrum based on the spread function, the processing device is to:
perform a deconvolution of the first frequency spectrum using the spread function to obtain a compensated frequency spectrum.

8. A method comprising:
transmitting an optical beam towards a target;
receiving a return signal from the target;
generating an electrical signal comprising a plurality of frequencies in a first frequency spectrum;
determining a value for each of a plurality of scanning parameters associated with the target;
determining a spread function for the frequency spectrum based on the values for each of the plurality of scanning parameters; and
performing a correction of the frequency spectrum based on the spread function.

9. The method of claim 8, wherein determining the spread function for the frequency spectrum comprises
selecting the spread function from a plurality of spread functions based on the value for each of the plurality of scanning parameters.

10. The method of claim 9, further comprising:
calibrating each of the plurality of spread functions using selected values for the plurality of scanning parameters and an expected frequency spectrum.

11. The method of claim 10, wherein the plurality of scanning parameters comprises a range of a target, an azimuth of the target, an elevation of the target, an angular velocity of the scanning mirror, and a chirp rate of an optical source of the LIDAR system.

12. The method of claim 10, wherein calibrating each of the plurality of spread functions comprises
sampling a first signal at a mirror speed of zero using the selected values for the plurality of scanning parameters to determine the expected frequency spectrum;
sampling a second signal at a non-zero scanning mirror speed using the selected values for the plurality of scanning parameters to determine a doppler spread frequency spectrum; and
calculating the spread function associated with the selected values for the plurality of scanning parameters based on the expected frequency waveform and the doppler shifted frequency spectrum.

13. The method of claim 8, wherein performing the correction of the first frequency spectrum based on the spread function comprises:
determine a matched filter associated with the spread function; and
applying the matched filter to the first frequency spectrum to obtain a compensated frequency spectrum.

14. The method of claim 8, wherein performing the correction of the first frequency waveform based on the spread function comprises:
performing a deconvolution of the first frequency spectrum using the spread function to obtain a compensated frequency spectrum.

15. A light detection and ranging (LIDAR) apparatus, comprising:
an optical scanner to transmit an optical beam and receive a plurality of return signals from reflections of the optical beam;
an optical processing system coupled to the optical scanner, the optical processing system to generate an electrical signal from the plurality of return signals, the electrical signal comprising a plurality of frequencies in a first frequency spectrum;
a signal processing system coupled to the optical processing system, the signal processing system comprising:
a memory; and
circuitry coupled to the memory, the circuitry to:
determine a value for each of a plurality of scanning parameters associated with the optical scanner;
determine a spread function for the frequency spectrum based on the values for each of the plurality of scanning parameters; and
perform a correction of the frequency spectrum based on the spread function.

16. The LIDAR apparatus of claim 15, wherein to determine the spread function for the frequency spectrum, the processing device is to:
select the spread function from a plurality of spread functions based on the value for each of the plurality of scanning parameters.

17. The LIDAR apparatus of claim 16, wherein the processing device is further to:
calibrate each of the plurality of spread functions using selected values for the plurality of scanning parameters and an expected frequency spectrum.

18. The LIDAR apparatus of claim 17, wherein to calibrate each of the plurality of spread functions, the processing device is to:
sample a first signal at a mirror speed of zero using the selected values for the plurality of scanning parameters to determine the expected frequency spectrum;
sample a second signal at a non-zero scanning mirror speed using the selected values for the plurality of scanning parameters to determine a doppler spread frequency spectrum; and
calculate the spread function associated with the selected values for the plurality of scanning parameters based on the expected frequency spectrum and the doppler shifted frequency spectrum.

19. The LIDAR apparatus of claim 15, wherein to perform the correction of the first frequency spectrum based on the spread function, the processing device is to:
determine a matched filter associated with the spread function; and
apply the matched filter to the first frequency spectrum to obtain a compensated frequency spectrum.

20. The LIDAR apparatus of claim 15, wherein to perform the correction of the first frequency spectrum based on the spread function, the processing device is to:
perform a deconvolution of the first frequency spectrum using the spread function to obtain a compensated frequency spectrum.
